(19) United States
(12) Patent Application Publication
(10) Pub. No.: US 2024/0333037 A1
(43) Pub. Date: Oct. 3, 2024

(54) POWER RECEPTION DEVICE, POWER SUPPLY DEVICE, POWER SUPPLY SYSTEM, AND METHOD

(71) Applicant: KABUSHIKI KAISHA TOSHIBA, Tokyo (JP)

(72) Inventors: Tomoko ADACHI, Kawasaki Kanagawa (JP); Toshiya MITOMO, Yokohama Kanagawa (JP)

(73) Assignee: KABUSHIKI KAISHA TOSHIBA, Tokyo (JP)

(21) Appl. No.: 18/596,752

(22) Filed: Mar. 6, 2024

(30) Foreign Application Priority Data
Mar. 27, 2023 (JP) 2023-049782

(51) Int. Cl. H02J 50/20; H02J 50/80; H04B 7/24

(52) U.S. Cl. CPC H02J 50/20; H02J 50/80; H04B 7/24

(57) ABSTRACT

According to one embodiment, a power reception device, includes: a power receiver circuit configured to receive a wireless signal including at least one of a wireless power supply signal or a wireless communication signal; and a processing circuit configured to determine whether the wireless signal includes the wireless power supply signal or not from a feature value of the wireless signal.

### CROSS-REFERENCE TO RELATED APPLICATIONS

This application is based upon and claims the benefit of priority from Japanese Patent Application No. 2023-049782, filed on Mar. 27, 2023; the entire contents of which are incorporated herein by reference.

### FIELD

Embodiments described herein relate generally to a power reception device, a power supply device, a power supply system, and a method.

### BACKGROUND

Wireless power supply technology by an electromagnetic wave has been developed. When the wireless power supply coexists with other wireless communication systems, it is necessary to determine (judge) the wireless power supply signal and the wireless communication signal.

### BRIEF DESCRIPTION OF THE DRAWINGS

FIG. 1 is a schematic diagram of a power supply system 100 in the first embodiment.

FIG. 2 is a diagram illustrating a configuration example of a power supply device 1 in a first embodiment.

FIG. 3 is a diagram illustrating a configuration example of a power reception device 2 in the first embodiment.

FIG. 4 is a sequence diagram illustrating a first operation example of the power supply device 1 and the power reception device 2 in the first embodiment.

FIG. 5 is a sequence diagram illustrating a second operation example of the power supply device 1 and the power reception device 2 in the first embodiment.

FIG. 6 is a sequence diagram illustrating a third operation example of the power supply device 1 and the power reception device 2 in the first embodiment.

FIG. 7 is a flowchart of an operation example of the power supply device 1 in the first embodiment.

FIG. 8 is a diagram illustrating a first example of an amplitude of a wireless power supply signal of the power supply device 1 in the first embodiment.

FIG. 9 is a diagram illustrating a second example of the amplitude of the wireless power supply signal of the power supply device 1 in the first embodiment.

FIG. 10 is a diagram illustrating a third example of the amplitude of the wireless power supply signal of the power supply device 1 in the first embodiment.

FIG. 11 is a diagram illustrating an example of an amplitude of a wireless communication signal.

FIG. 12 is a diagram illustrating an example of a power supply channel when power is supplied in a 5.7 GHz band.

FIG. 13 is a flowchart of an operation example of the power reception device 2 in the first embodiment.

FIG. 14 is a diagram illustrating a configuration example of a power reception device 2′ applicable to the first embodiment.

FIG. 15 is a diagram illustrating a first example of the necessity of transmission of a signal indicating received electric energy of the power reception device 2 in a modification.

FIG. 16 is a diagram illustrating a second example of the necessity of transmitting a signal indicating received electric energy of the power reception device 2 in the modification.

FIG. 17 is a diagram illustrating a third example of the necessity of transmission of a signal indicating received electric energy of the power reception device 2 in the modification.

FIG. 18 is a diagram illustrating a configuration example of the power supply device 1′ applicable to the first embodiment is provided.

FIG. 19 is a diagram illustrating a configuration example of the power reception device 2 applicable to the first embodiment.

FIG. 20 is a sequence diagram illustrating an operation example of a power supply device 1′ and a power reception device 2″ in the modification.

FIG. 21 is a diagram illustrating a configuration example of a power reception device 2′″ applicable to the first embodiment.

FIG. 22 is a diagram illustrating an example of the frequency of the wireless power supply signal of the power supply device 1 in the modification.

FIG. 23 is a diagram illustrating a configuration example of the power reception device 2″″ applicable to the first embodiment.

### DETAILED DESCRIPTION

According to one embodiment, a power reception device, includes: a power receiver circuit configured to receive a wireless signal including at least one of a wireless power supply signal or a wireless communication signal; and a processing circuit configured to determine whether the wireless signal includes the wireless power supply signal or not from a feature value of the wireless signal.

Hereinafter, embodiments of the present invention will be described in reference to the drawings. Disclosure is only an example, and invention is not limited by the contents described in the following embodiments. In the drawings, the size, shape, and the like may be schematically represented to make the description clearer. In the multiple drawings, corresponding elements are denoted by the same reference numerals, and detailed description may be omitted.

### First Embodiment

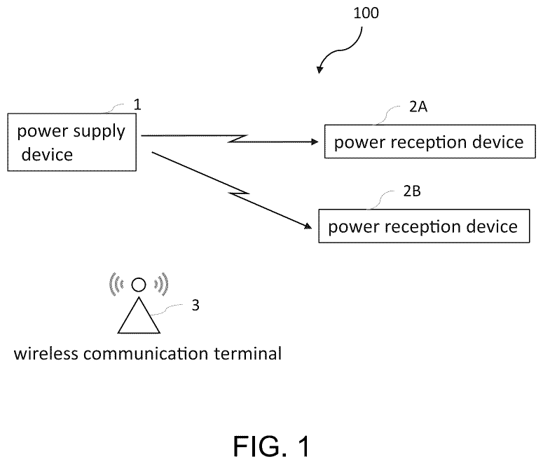

FIG. 1 is a schematic diagram of a power supply system 100 in a first embodiment. The power supply system 100 includes a power supply device 1 and power reception devices 2A and 2B. Hereinafter, when the power reception devices 2A and 2B are collectively referred, or when a common part is explained, it is simply called a power reception device 2. In the power supply system 100 illustrated in FIG. 1, one power supply device 1 and two power reception devices 2 are used, but the number of both the power supply devices 1 and the power reception devices 2 is not limited. In the power supply system 100, wireless power supply (wireless power transmission) is performed from the power supply device 1 to the power reception device 2. Hereinafter, a signal for the wireless power supply is also called a wireless power supply signal. The power reception device 2 generates DC power by receiving the wireless power supply signal from the power supply device 1.

When wireless power is supplied from the power supply device 1 to the power reception device 2, the power supply device 1 may perform a test of the wireless power supply to the power reception device 2. The power reception device 2 measures received electric energy as the test of the wireless power supply and transmits the signal indicating the received electric energy to the power supply device 1. The power supply device 1 determines items related to the wireless power supply based on information on the received electric energy by the power reception device 2.

In this case, there is a case that the wireless communication terminal 3 exists in an environment where the power supply system 100 is arranged. The wireless communication terminal 3 is at least a part of devices constituting an existing wireless system. Since the wireless communication terminal 3 also performs communication, not only the wireless power supply signal but also both the wireless power supply signal and a wireless communication signal are included (mixed) depending on time in the wireless signal received by the power reception device 2. In the case of wireless communication between the power supply device 1 and the power reception device 2, the power reception device 2 can identify the wireless power supply signal and the wireless communication signal by using a frequency band different from the wireless power supply signal. For example, when the wireless power supply signal transmitted by the power supply device 1 is in a 5.7 GHZ band and wireless communication between the power supply device 1 and the power reception device 2 uses a 2.4 GHz band, the power reception device 2 can identify the wireless power supply signal from the wireless communication signal.

However, when a frequency band communicated by the wireless communication terminal 3 is in a vicinity of the frequency band of the wireless power supply signal transmitted by the power supply device 1, the wireless power supply signal from the power supply device 1 and the wireless communication signal from the wireless communication terminal 3 may coexist in the wireless signal received by the power reception device 2. For example, when a wireless communication terminal 3 communicates through a wireless LAN and has a communication frequency band of 5 GHZ and the frequency band of the wireless power supply signal of the power supply device 1 is the 5.7 GHZ, the wireless power supply signal and the wireless communication signal may be mixed with a wireless signal received by 10 the power reception device 2.

Further, the power supply device 1 performs carrier sensing for confirming whether the wireless communication terminal 3 is communicating in a vicinity of the power supply device 1 when performing the wireless power supply or not. As a result of carrier 15 sensing, when the wireless communication terminal 3 is communicating, the power supply device 1 waits for transmission of the wireless power supply signal and transmits the wireless power supply signal after the communication is completed.

Therefore, the power reception device 2 does not know whether the wireless signal received by the power reception device 2 is the wireless power supply signal or the wireless communication signal, and determination (judgement) of which it is becomes necessary. This is because a measurement result of the electric energy received by the power reception device 2 is required for setting transmission of the wireless power supply signal of a power supply device.

The power supply device 1 of the first embodiment transmits the wireless power supply signal including a feature value different from the wireless communication signal, and the power reception device 2 determines whether the wireless signal includes the wireless power supply signal from the feature value of the received wireless signal. Thus, the power reception device 2 can discriminate whether the wireless signal received by the power reception device 2 is the wireless power supply signal or the other wireless communication signal. As a side note, the wireless communication signal also includes a signal used for communication between the power supply device 1 and the power reception device 2.

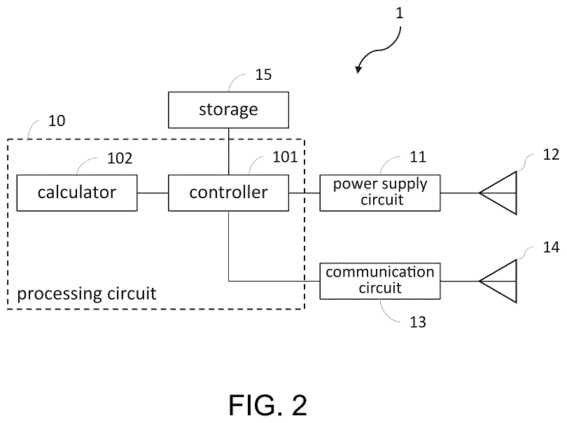

FIG. 2 is a diagram illustrating a configuration example of the power supply device 1 in the first embodiment. The supply device 1 includes a processing circuit 10, a power supply circuit 11, an antenna 12, a communication circuit 13, an antenna 14, and a storage 15. The processing circuit 10 includes a controller 101 and a calculator 102.

The power supply circuit 11 transmits the wireless power supply signal including the feature value different from the wireless communication signal through the antenna 12 and performs the wireless power supply to the power reception device 2. As the feature values, electric power (amplitude), frequency, etc. are mentioned, and details are described later. The wireless power supply signal is radiated from the antenna 12 as an electromagnetic wave. The radiation of the electromagnetic wave indicating the wireless power supply signal is also called the transmission of the wireless power supply signal. The power supply circuit 11 receives the wireless power supply signal and an instruction from the controller 101 to perform the wireless power supply. The instruction includes, for example, at least one item such as a time slot, a time length, the electric power (amplitude), a phase, the frequency band, and a transmission direction for transmitting the wireless power supply signal. These items are items on the wireless power supply. A plurality of patterns (hereinafter referred to as power transmission patterns) may be set by one or more of these items.

As the frequency band in which the wireless power supply signal is transmitted, for example, 5727-5875 MHz for ISM (Industrial scientific and medical) band or narrower 5738-5766 MHz is used. These frequency bands are called 5.7 GHZ bands. The bandwidth of the wireless power supply signal is set to a predetermined width of, for example, less than 100 KHz. The transmission power of the wireless power supply signal is, for example, 10 W at maximum, and e. i. r. p. (equivalent isotropic radiation power) is 1 kW. The electromagnetic wave of the wireless power supply signal is a continuous wave (CW) and may be non-modulated.

The power supply circuit 11 performs carrier sensing for confirming whether a wireless communication terminal 3 is communicating or not (whether the wireless communication signal exists or not) in the vicinity of the power supply device 1 when transmitting the wireless power supply signal. The carrier sensing is performed so as not to disturb the communication of the wireless communication terminal 3 by the wireless power supply of the power supply device 1. That is, for the coexistence of the power supply device 1 and the wireless communication terminal 3. The power supply circuit 11 receives the electromagnetic wave through the antenna 12 and transmits the wireless communication signal or waits according to the result.

The communication circuit 13 modulates the wireless communication signal and transmits it through the antenna 14 and receives and demodulates the wireless communication signal through the antenna 14 to perform wireless communication. The other party of wireless communication is, for example, the power reception device 2. The communication circuit 13 transmits and receives a signal including information on the wireless power supply to and from the power reception device 2 by wireless communication. The information related to the wireless power supply is, for example, prior communication exchange required for the wireless power supply, request information for the power reception device 2 measuring the electric energy to be received from the wireless power supply signal, information on the received electric energy, and information on required electric energy. The information on the received electric energy and the information on the requested electric energy are sent to the controller 101.

A frequency band in which the communication circuit 13 performs wireless communication is different from the frequency band in which the power supply circuit 11 performs the wireless power supply. For example, when the communication circuit 13 uses Bluetooth™ (BLE: Bluetooth Low Energy) for wireless communication, the frequency band to be used is 2400-2500 MHz band (ISM, 2.4 GHz band).

The storage 15 holds information according to an instruction of the controller 101. The held information is information related to the wireless power supply, for example, identification information on devices (power supply device 1 and power reception device 2) constituting the power supply system 100, information indicating an interaction necessary for the wireless power supply, information on items related to the wireless power supply, information on the received electric energy from the power reception device 2, and information on required electric energy. An optional storage medium, for example, memory or storage can be set as the storage 15.

The controller 101 controls each part of the power supply device 1. For example, the wireless power supply signal is generated to instruct the wireless power supply to the power supply circuit 11, or a signal (which may be called request signal of the measurement, or a first signal) for requesting the power reception device 2 to measure electric energy is generated and sent to the communication circuit 13. The controller 101 sends information on the wireless power supply to the calculator 102 described later and instructs to calculate items on the wireless power supply. The controller 101 makes the storage 15 hold information sent from each place and reads it as needed.

The calculator 102 calculates and determines the item related to the wireless power supply based on the information sent from the controller 101. For example, based on at least one of the information on the received electric energy, the electric power of the wireless power supply signal when the power reception device 2 measures the received electric energy, or the information on the required electric energy, items related to the wireless power supply are calculated. The calculation result is sent to the controller 101 and used for the generation of the wireless power supply signal and the instruction to the power supply circuit 11. The calculation result may be held in the storage 15. When a power transmission pattern is set to the wireless power supply, the calculator 102 may determine the power transmission pattern by the item related to one or more the wireless power supply or may determine a combination by selecting from a plurality of existing power transmission patterns.

The power supply device 1 is explained above. The processing circuit 10 provided in the power supply device 1 is one or more processing circuits including a control device and an arithmetic unit. The processing circuit is realized by an analog or digital circuit or the like. For example, a general-purpose processor, a central processing unit (CPU), a microprocessor, a digital signal processor (DSP), an ASIC, an FPGA, and a combination thereof are applicable. Also, the processing circuit 10 may be executed on these processing circuits by software or a program. Also, the antennas 12 and 14 may be shared, and when there is a plurality of power supply devices 1, at least a part of the explained components of the power supply device 1 may be shared.

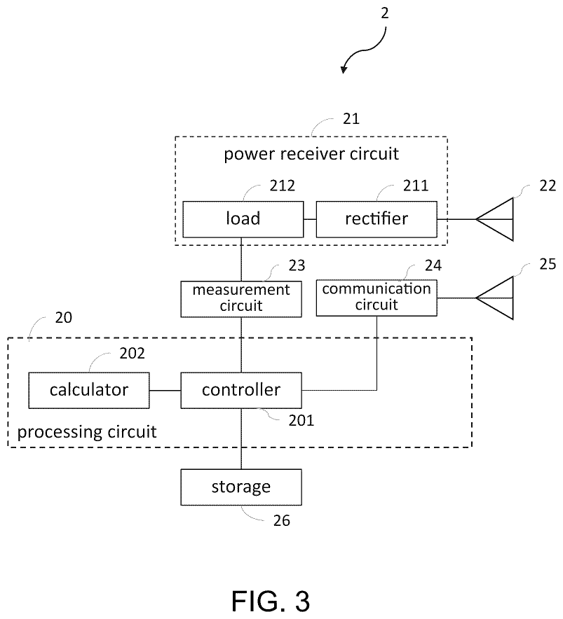

FIG. 3 is a diagram illustrating a configuration example of the power reception device 2 in the first embodiment. The power reception device 2 includes a processing circuit 20, a power receiver circuit 21, an antenna 22, a measurement circuit 23, a communication circuit 24, an antenna 25, and a storage 26. The processing circuit 20 includes a controller 201 and a calculator 202, and the power receiver circuit 21 includes a rectifier 211 and a load 212.

The power receiver circuit 21 receives a wireless signal through the antenna 22 and generates DC power. Especially, the power receiver circuit 21 receives the wireless power supply signal from the power supply device 1 and generates DC power. More specifically, the power receiver circuit 21 receives the electromagnetic wave radiated as the wireless power supply signal from the power supply device 1 and generates DC power. Here, reception of the electromagnetic wave indicating the wireless signal is called reception of the wireless signal, reception of the electromagnetic wave indicating the wireless power supply signal is called reception of the wireless power supply signal, and reception of the electromagnetic wave indicating the wireless communication signal is also called reception of the wireless communication signal.

The rectifier 211 converts AC power of the received wireless signal into DC power. The DC power is measured by the measurement circuit 23 via a load 212. The measurement circuit 23 measures the electric energy (received electric energy) of DC power sent from a load 212. A measurement result of the electric energy is sent to the controller 201. The measurement circuit 23 may be called a first measurement circuit.

The frequency band where the power receiver circuit 21 receives the wireless signal is the same as the frequency band of the wireless power supply signal or may be a wider frequency band including the frequency band of the wireless power supply signal. For example, when the power supply device 1 selects the frequency band (channel) for transmitting the wireless power supply signal from 5727-5875 MHZ (or 5738-5766 MHZ), the power receiver circuit 21 may use a 5 GHZ band including 5470-5725 MHZ (hereinafter referred to as 5.6 GHZ band) used by a wireless LAN (local area network) as the frequency band for receiving a wireless signal. Thus, the configuration of the power receiver circuit 21 can be made simple and inexpensive.

The communication circuit 24 modulates the wireless communication signal and transmits it through the antenna 25 and receives and demodulates the wireless communication signal through the antenna 25 to perform wireless communication. The other party of wireless communication is, for example, the power supply device 1. The communication circuit 24 transmits and receives a signal including information on the wireless power supply to and from the power supply device 1 by wireless communication. The information related to the wireless power supply is, for example, prior interaction required for the wireless power supply, request information for the power reception device 2 measuring the electric energy, information on the electric energy received by the power reception device 2, and information on the required electric energy. The received request information for measuring the electric energy is sent to the controller 201.

A frequency band in which the communication circuit 24 performs wireless communication is the same as the frequency band in which the communication circuit 13 of the power supply device 1 performs wireless communication, and the frequency band is different from the frequency band in which the power supply circuit 11 performs the wireless power supply.

The storage 26 holds information according to the instruction of the controller 201. The held information is information related to the wireless power supply, for example, identification information on devices (the power supply device 1 and the power reception device 2) included in the power supply system 100, information indicating an interaction necessary for the wireless power supply, the request information for measuring the received electric energy, and power consumption information on each part of the power reception device 2. An optional storage medium explained by the storage 15 can be mounted as the storage 26.

The controller 201 controls each part of the power reception device 2. For example, a signal (which may be called a second signal) including information indicating the measured electric energy and a signal including information indicating the requested electric energy are generated and the controller 201 instructs the communication circuit 24 to transmit to the power supply device 1. The controller 201 sends information on the wireless power supply to the calculator 202 to be described later, instructs to calculate the requested electric energy to the calculator 202, makes the storage 26 hold information sent from each place, and reads as necessary.

The calculator 202 calculates the required electric energy based on the information sent from the controller 201. For example, the calculator 202 calculates the required electric energy is calculated based on at least one of the measured electric energy or power consumption information on each part of the power reception device 2. The calculation result is sent to the controller 201 and used for generation of the signal including information indicating the required electric energy and the instruction to the communication circuit 24. The calculation result may be held in the storage 26.

The power reception device 2 is explained above. An optional processing circuit explained by the processing circuit 10 of the power supply device 1 can be mounted as the processing circuit 20 provided in the power reception device 2. Also, the processing circuit may be executed on the processing circuit by software or a program. The antennas 22 and 25 may be shared, and when a plurality of power reception devices 2 exist, at least a part of the explained components of the power reception device 2 may be shared.

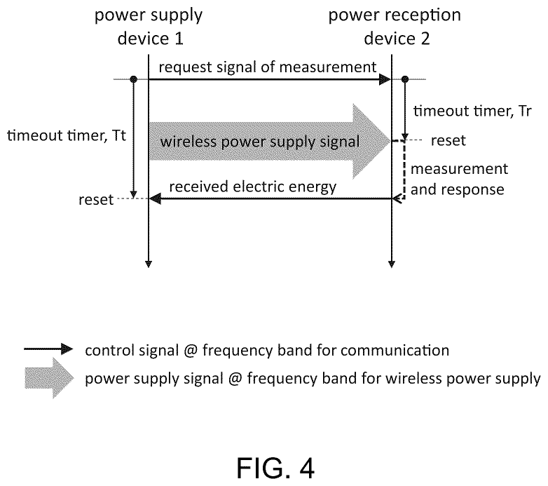

The operation examples of the power supply device 1 and the power reception device 2 in this embodiment are explained by using FIGS. 4-6. FIG. 4 is a sequence diagram illustrating a first operation example of the power supply device 1 and the power reception device 2 in the first embodiment. The first operation example represents processes from transmission of the request signal of the measurement of the electric energy to the power reception device 2 by the power supply device 1 to reception of the signal indicating the received electric energy from the power reception device 2 by the power supply device 1. First, the power supply device 1 transmits the request signal of the measurement of the electric energy to be received to the power reception device 2. The power supply device 1 transmits the wireless power supply signal to the power reception device 2. The power reception device 2 receives the wireless power supply signal and measures the received electric energy. The power reception device 2 transmits the signal indicating the measured electric energy to the power supply device 1, and the power supply device 1 receives it.

The power supply device 1 sets a time-out timer (time Tt) waiting for the signal indicating the received electric energy after transmitting the request signal of the measurement of the electric energy to be received. This time Tt is set to a sufficient time for the power reception device 2 normally to receive the wireless power supply signal, to measure the received electric energy, and to transmit the signal indicating the measured electric energy. That is, when the power supply device 1 cannot receive the signal indicating the received electric energy even after a lapse of the time Tt, it is estimated that any one of the request signal of the measurement of the electric energy to be received transmitted by the power supply device 1, the wireless power supply signal, and the signal indicating the received electric energy did not reach the transmission destination, or that there was an error in the operation of the power reception device 2.

The power reception device 2 sets a time-out timer (time Tr) waiting for the wireless power supply signal after receiving the request signal of the measurement of the electric energy to be received. This time Tr is set to a sufficient time for the power reception device 2 to normally receive the wireless power supply signal. That is, when the wireless power supply signal is not received even after a lapse of time Tr, it is estimated that the wireless power supply signal did not reach the power reception device 2 or that there was an error in the operation of the power supply device 1. In the first operation example, a signal indicating received electric energy reaches the power supply device 1, and it is indicated that the operation is normal.

After the first operation example, the power supply device 1 determines the item related to the wireless power supply based on the received electric energy and performs the wireless power supply.

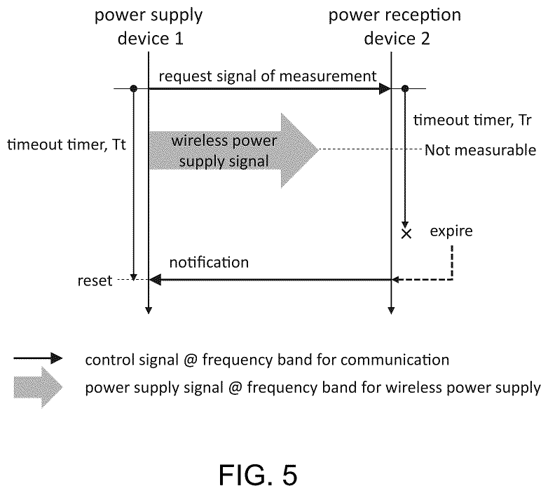

FIG. 5 is a sequence diagram illustrating a second operation example of the power supply device 1 and the power reception device 2 in the first embodiment. The second operation example represents processes from the transmission of the request signal of the measurement of the electric energy to be received to the power reception device 2 by the power supply device 1 to the reception of a notification indicating that the power reception device 2 cannot receive the wireless power supply signal by the power supply device 1. First, the power supply device 1 transmits the request signal of the measurement of electric energy to be received to the power reception device 2 and sets the time-out timer (time Tt) waiting for the signal indicating the received electric energy. The power reception device 2 receives the request signal of the measurement and sets the time-out timer (time Tr) waiting for the wireless power supply signal.

The power supply device 1 transmits the wireless power supply signal to the power reception device 2. However, the power reception device 2 cannot receive the wireless power supply signal and cannot measure the received electric energy. After the lapse of the time Tr of the time-out timer, the power reception device 2 transmits the notification indicating that the wireless power supply signal cannot be received to the power supply device 1, and the power supply device 1 receives the notification.

The power supply device 1 transmits the request signal of the measurement of the electric energy to be received to the power reception device 2 again after the second operation example.

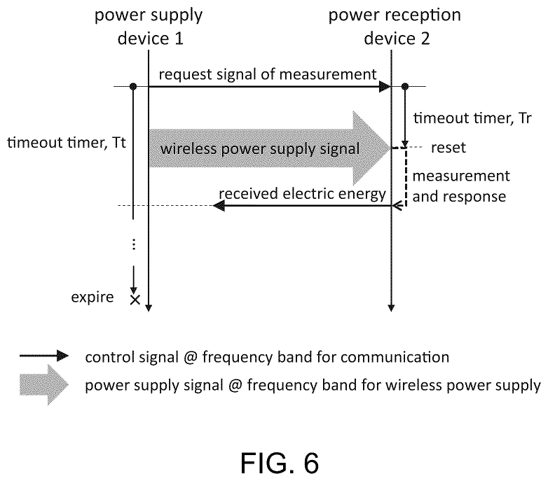

FIG. 6 is a sequence diagram illustrating a third operation example of the power supply device 1 and the power reception device 2 in the first embodiment. The third operation example represents processes from transmission of the request signal of the measurement of the electric energy to be received to the power reception device 2 by the power supply device 1 to the lapse of time Tt, wherein the power supply device 1 not being able to receive the signal indicating the received electric energy from the power reception device 2. First, the power supply device 1 transmits the request signal of the measurement of electric energy to be received to the power reception device 2 and sets the time-out timer (time Tt) waiting for the signal indicating the received electric energy. The power reception device 2 receives the request signal of the measurement and sets the time-out timer (time Tr) waiting for the wireless power supply signal.

The power supply device 1 transmits the wireless power supply signal to the power reception device 2. The power reception device 2 receives the wireless power supply signal and measures the received electric energy. The power reception device 2 transmits the signal indicating the measured electric energy to the power supply device 1, but the power supply device 1 cannot receive the signal and the time Tt of the time-out timer elapses.

The power supply device 1 transmits the request signal of the measurement of the electric energy to be received to the power reception device 2 again after the second operation example.

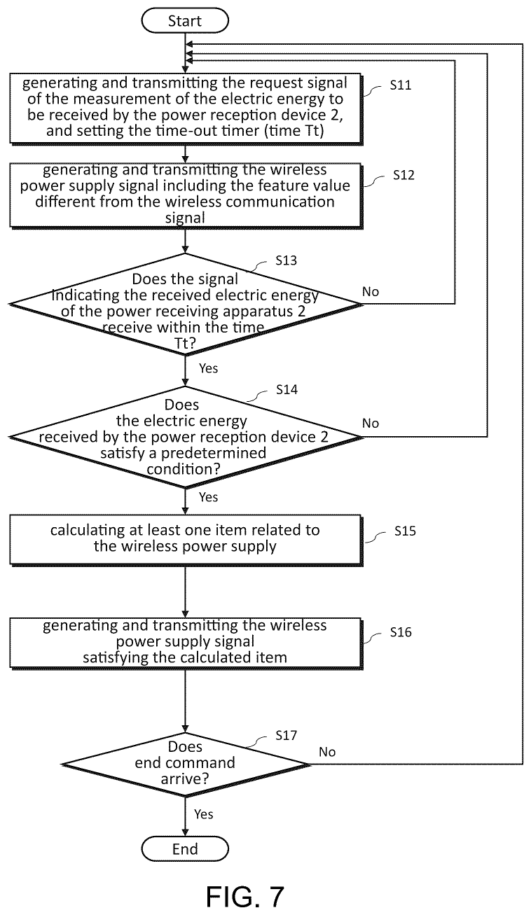

FIG. 7 is a flowchart of an operation example of the power supply device 1 in the first embodiment. The operation example of the power supply device 1 is explained by using FIG. 7. First, the controller 101 generates the request signal of the measurement of the electric energy to be received by the power reception device 2, and the communication circuit 13 transmits the request signal through the antenna 14. After the transmission, the controller 101 sets the time-out timer (time Tt) for waiting for a signal indicating received electric energy (step S11).

The controller 101 generates the wireless power supply signal including the feature value different from the wireless communication signal, and the power supply circuit 11 transmits the wireless power supply signal through the antenna 12 (step S12). The feature value is explained below.

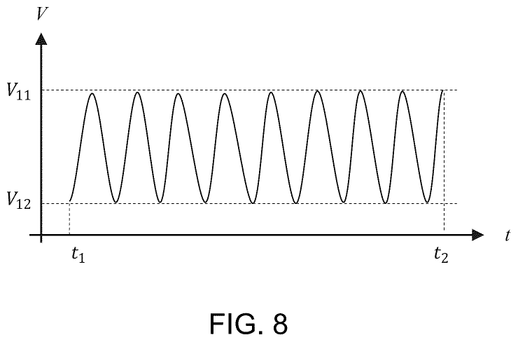

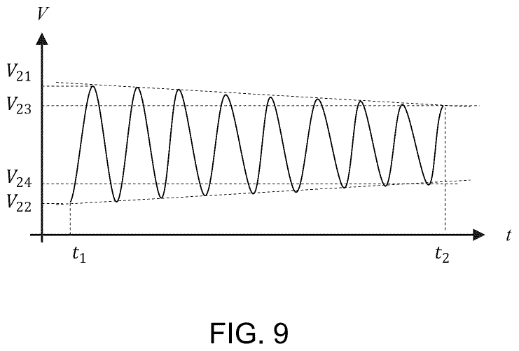

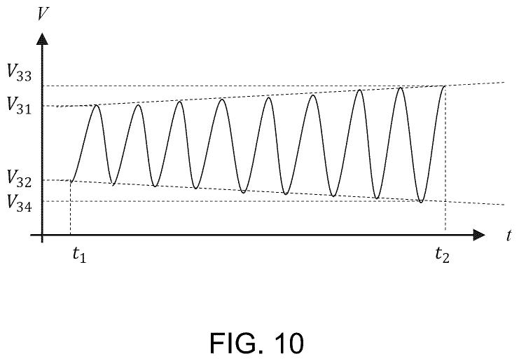

The feature value of the wireless power supply signal is set to at least one of setting an amplitude to a predetermined range, setting a time change of the amplitude to a positive predetermined range, or setting a time change of the amplitude to a negative predetermined range, within a predetermined time. In FIG. 8-FIG. 10, a first example to a third example of the amplitude of the wireless power supply signal from time t1 to t2 are illustrated. In FIG. 8, the amplitude of the wireless power supply signal is made constant. The amplitude is (V11 to V12) in FIG. 9, but the amplitude may be within a predetermined range (within a first range) in consideration of amplitude fluctuation, since there is amplitude fluctuation in an actual environment because of noise, reflection, diffraction, or fluctuation of amplitude and phase called fading. FIG. 9 and FIG. 10 are diagrams illustrating examples in which a time change of the amplitude of the wireless power supply signal is made to be positive or negative within predetermined range. The time change of the amplitude in FIG. 9 is (V21−V23)/(t2−t1) or (V24−V22)/(t2−t1), but the time change may be within a predetermined range (within a second positive range) in consideration of fluctuation of the amplitude. The time change of the amplitude in FIG. 10 is (V31−V33)/(t2−t1) or (V34−V32)/(t2−t1), but the time change may be within a predetermined range (within a negative third range) in consideration of fluctuation of the amplitude. Also, as a determination method within the predetermined range, the controller 101 may determine by learning the DC power of the wireless power supply signal and the DC power of the wireless communication signal in advance.

When the feature value is included in the wireless power supply signal, a tendency different from that of the wireless communication signal is obtained when the wireless power supply signal is converted into the DC power. When the amplitude of the wireless power supply signal is set within the predetermined range, the value of the converted the DC power is also within the predetermined range. When the time change of the amplitude of the wireless power supply signal is set within the positive or negative predetermined range, the time change of the converted DC power is also settled within the positive or negative predetermined range.

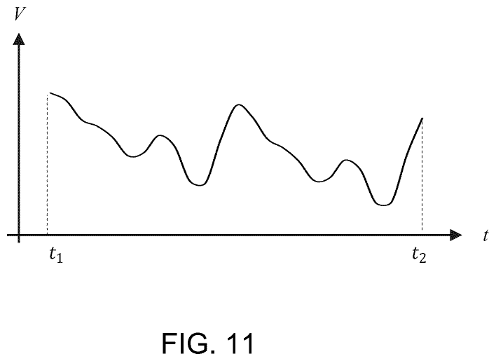

On the other hand, FIG. 11 is a diagram illustrating an example of an amplitude of the wireless communication signal. When modulation for including information (data) is applied to the wireless communication signal, the amplitude of the wireless communication signal is varied with time, and a time change of the amplitude of the wireless communication signal is also varied compared with that of the wireless power supply signal, and the amplitude varies positive and negative depending on time. Thus, the wireless communication signal converted into the DC power varies with time (this variation exceeds a range where noise and distance attenuation are taken into account) and the time change of the DC power also exceeds the positive or negative predetermined range.

As mentioned above, when the amplitude is set to the predetermined range as the feature value of the power supply signal or the time change of the amplitude is set to the positive or negative predetermined range, the power reception device 2 can determine whether the wireless signal received includes the wireless power supply signal or not when the power reception device 2 converts the wireless signal into DC power.

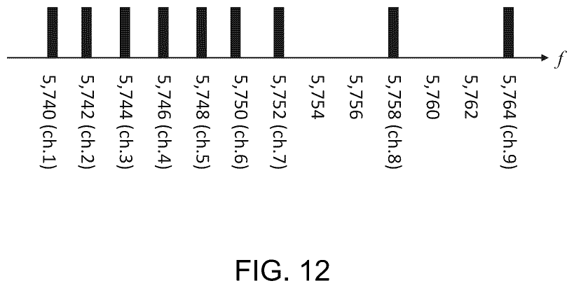

When the power supply circuit 11 transmits the wireless power supply signal, the power supply circuit 11 uses a predetermined frequency band. This frequency band is also called a channel (power supply channel). FIG. 12 is a diagram illustrating an example of the power supply channel in the case of supply in the 5.7 GHZ band, and nine channels among 5740-5764 MHz are set. The power supply circuit 11 transmits the wireless power supply signal from these channels by using a predetermined channel. The channels illustrated in FIG. 12 is one example, and the channel can be variously set even when the wireless power supply signal is transmitted in the same 5.7 GHz band.

The operation of the power supply device 1 is continuously explained. After the step S12, the control circuit 101 waits for reception of the signal indicating the received electric energy of the power receiving apparatus 2 through the communication circuit 13 for the time Tt (step S13). When the communication circuit 13 receives the signal indicating the received electric energy and the controller 101 receives the information indicating the received electric energy within the time Tt (step S13: Yes), an advance is made to a step S14. The controller 101 resets the time-out timer (time Tt). On the other hand, when the control circuit 101 cannot receive information indicating the received electric energy within the time Tt (step S13: No), the control circuit 101 estimates whether any of the request signal of the measurement of the electric energy to be received transmitted by the power supply device 1, the wireless power supply signal and the signal indicating the received electric energy has not reached the transmission destination or the operation of the power reception apparatus 2 has an error. In this case, the process returns to the step S11.

In a step S14, the controller 101 confirms whether the electric energy received by the power reception device 2 satisfies a predetermined condition from the received information indicating the received electric energy or not. For example, when the power reception device 2 sets the lower limit or a range of the received electric energy of the transmitted the wireless power supply signal, and when the received electric energy deviating from the lower limit and the range of the electric energy does not satisfy a predetermined condition, the controller 101 estimates that the power reception device 2 does not receive the electric energy by the wireless power supply signal. When the received electric energy of the power reception device 2 does not satisfy the predetermined condition (step S14: No), the process returns to the step S11. When the received electric energy of the power reception device 2 satisfies the predetermined condition (step S14: Yes), the controller 101 sends information indicating the received electric energy of the power reception device 2 to the calculator 102 and instructs a calculation of the items related to the wireless power supply.

The calculator 102 calculates at least one item related to the wireless power supply such as the time slot, the time length, the power (amplitude), the phase, the frequency band, and the transmission direction for transmitting the wireless power supply signal based on the information indicating the electric energy received by the power reception device 2, thereby determining the items related to the wireless power supply (step S15). The calculated item is sent to the controller 101.

The controller 101 generates the wireless power supply signal satisfying the calculated item and instructs the power supply circuit 11 to perform the wireless power supply satisfying the calculated item. The power supply circuit 11 transmits the wireless power supply signal through the antenna 12 based on the wireless power supply signal and the instruction (step S16).

The controller 101 confirms whether an end command for ending the operation of the power supply device 1 arrives or not (step S17). The end command is a command for ending the operation of the power supply device 1 in this flow. The end command is sent to the controller 101 by inputting to the power supply device 1 by a user or acquiring a signal including the end command by the power supply device 1. The end command may be a command for immediately ending the operation of the power supply device 1.

When the end command does not reach the controller 101 (step S17: No), the process returns to the step S11. On the other hand, when the end command reaches the controller 101 (step S17: Yes), the flow is ended and the power supply device 1 ends the operation. The step S17 may be performed independently of the main flow in a lapse of a predetermined time or may be performed when the end command arrives at the controller 101. After the step S17: No, the process returns to step S16, and the generation and transmission of the wireless power supply signal satisfying the determined item may be repeated.

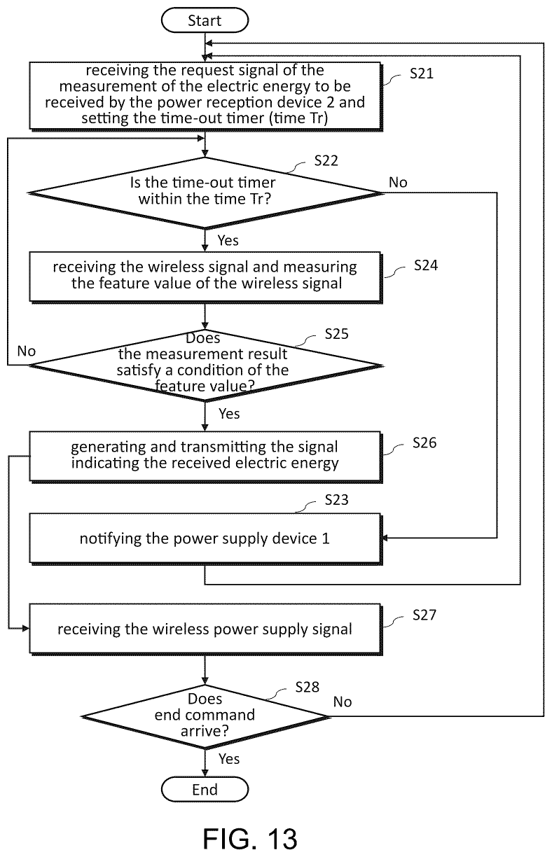

The operation example of the power supply device 1 of the embodiment is explained above. FIG. 13 is a flowchart of an operation example of the power reception device 2 in the first embodiment. The operation example of the power reception device 2 is explained using FIG. 13.

The communication circuit 24 receives the request signal of the measurement of the electric energy to be received by the power reception device 2 from the power supply device 1 through the antenna 25. The communication circuit 24 sends information indicating the request to the controller 201, and the controller 201 sets the time-out timer (time Tr) waiting for the wireless power supply signal (step S21).

When the time-out timer exceeds the time Tr (step S22: No), the controller 201 estimates that the wireless power supply signal does not reach the power reception device 2 or that there is an error in the operation of the power supply device 1. In this case, the controller 201 generates a notification signal to the power supply device 1 and makes the communication circuit 24 transmit it through the antenna 25 (step S23). Information included in the notification signal includes information indicating a request for resending the request signal of the measurement of the electric energy to be received by the power reception device 2 in the power supply signal 1, information indicating that the received electric energy is zero, and the like. After the step S23, the process returns to the step S21 for redoing.

On the other hand, when the time-out timer is within the time Tr (step S22: Yes), the power receiver circuit 21 receives the wireless signal, and the measurement circuit 23 measures the feature value of the wireless signal (step S24). In this embodiment, the power receiver circuit 21 converts the wireless signal into DC power, and the measurement circuit 23 measures at least one of the values of the DC power or the time change of the DC power as the feature value and transmits a measurement result to the controller 201.

The controller 201 determines whether the received wireless signal includes the wireless power supply signal from the measurement result sent from the measurement circuit 23, or not (step S25). More specifically, the controller 201 confirms whether the measurement result satisfies a condition of the feature value of the wireless power supply signal or not and determines it. The controller 201 can determine whether the received wireless signal includes the wireless power supply signal by the difference between the feature values of the wireless power supply signal and the wireless communication signal explained in the flow chart of the power supply device 1, or not. When the controller 201 determines that the wireless power supply signal is not included in the received wireless signal (step S25: No), the process returns to the step S22.

When the controller 201 determines that the wireless power supply signal is included in the received wireless signal (step S25: Yes), the controller 201 generates the signal indicating the received electric energy of the wireless signal determined to include the wireless power supply signal, and the communication circuit 24 transmits the signal to the power supply device 1 through the antenna 25 (step S26). The controller 201 resets the time-out timer (Time Tr).

The power supply device 1 determines the item related to the wireless power supply based on the received electric energy and transmits the wireless power supply signal satisfying the item. The power receiver circuit 21 waits for the reception of the wireless power supply signal and receives when the wireless power supply signal is transmitted (step S27).

The controller 201 confirms whether an end command for ending the operation of the power reception device 2 has arrived or not (step S28). The end command is a command for ending the operation of the power reception device 2 in this flow. The end command is sent to the controller 201 by inputting to the power reception device 2 by a user or acquiring a signal including the end command by the power reception device 2. The end command may be a command for immediately ending the operation of the power reception device 2.

When the end command does not reach the controller 201 (step S28: No), the process returns to the step S21. On the other hand, when the end command reaches the controller 201 (step S28: Yes), the flow ends and the power reception device 2 ends the operation. The step S28 may be performed independently of the main flow in a lapse of a predetermined time or may be performed when the end command arrives at the controller 201. After the step S28: No, the process returns to s27, and the reception of the wireless power supply signal satisfying the determined item may be repeated.

The operation example of the power reception device 2 of this embodiment is explained above. The power supply device 1 and the power reception device 2 described in this embodiment are examples, and modifications can be variously mounted and executed. Hereinafter, modifications of the power supply device 1 and the power reception device 2 are explained. The embodiments and modifications described below can be used in combination with each other. In the modifications, when the components and steps described in this embodiment are the same, their explanations are omitted by adding the same code.

### Modification 1

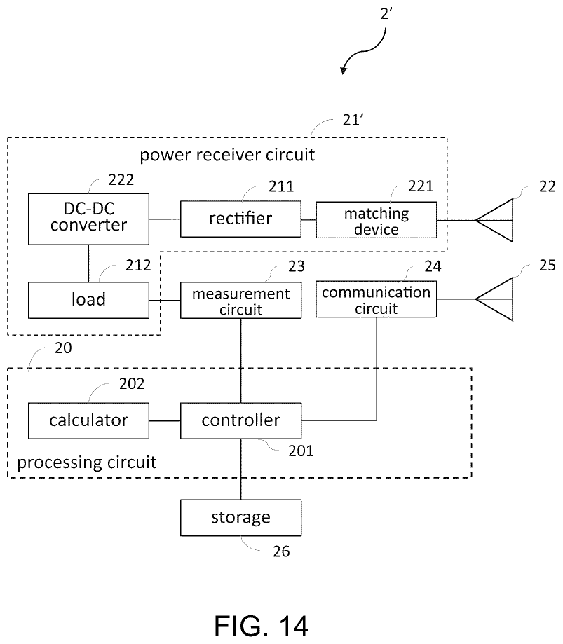

The power receiver circuit 21 of the power reception device 2 includes the rectifier 211 and the load 212 and may further include a matching device and a DC-DC converter. FIG. 14 is a diagram illustrating a configuration example of a power reception device 2′ applicable to the first embodiment.

The power reception device 2′ is provided with a power receiver circuit 21′ instead of the power receiver circuit 21 of the power reception device 2. The power receiver circuit 21′ includes the rectifier 211 and the load 212 and further includes the matching device 221 and the DC-DC converter 222.

The matching device 221 is provided between the antenna 22 and the rectifier 211. The matching device 221 performs impedance matching of the antenna 22 and the rectifier 211. Thus, a loss between the antenna 22 and the rectifier 211 can be reduced.

The DC-DC converter 222 is provided between the rectifier 211 and the load 212. The DC-DC converter 222 converts the DC voltage rectified by the rectifier 211. Consequently, the DC voltage can be stabilized and an operating voltage of the power reception device 2 can be attained.

In FIG. 14, both the matching device 221 and the DC-DC converter 222 are provided, but either one of them may be provided.

### Modification 2

In the determination of the item related to the wireless power supply of the power supply device 1 in the step S15, the calculator 102 may further perform calculation based on at least one of information indicating the transmission power of the wireless power supply signal when the power reception device 2 measures the electric energy or information indicating the requested electric energy of the power reception device 2. The communication circuit 13 receives the signal including the information indicating the required electric energy of the power reception device 2 from the power reception device 2 and sends it to the controller 101. The communication circuit 13 may receive the signal at an optional timing before the step S15 or may receive the signal in advance. The calculator 102 receives the information indicating the requested electric energy from the controller 101. The calculator 102 receives the information indicating the transmission power of the wireless power supply signal when the power reception device 2 measures the electric energy from the controller 101 before steps S11 to s15.

In the power reception device 2, the calculator 202 may calculate the required electric energy of the power reception device 2 based on at least one of the measured electric energy or the power consumption of the component of the power reception device 2. Information indicating the calculated required electric energy is sent to the controller 201. The controller 201 may generate a signal indicating the required electric energy and make the communication circuit 24 transmit the signal to the power supply device 1 through the antenna 25. When the calculator 202 uses the measured electric energy, the calculator 202 performs the calculation between steps S26-S27. On the other hand, when the calculator 202 uses the power consumption of the component of the power reception device 2, the calculator 202 can perform the calculation regardless of the step if the information on the power consumption can be acquired in advance. The power reception device 2 needs to transmit the signal indicating the required electric energy before the step S27, when the power supply device 1 determines the item related to the wireless power supply signal in consideration of the required electric energy of the power reception device 2.

As in this modification, the power supply device 1 can determine the items related to the power supply so as to provide more efficient power supply based on at least one of the transmission power of the wireless power supply signal when the power reception device 2 measures the electric energy or the required electric energy of the power reception device 2.

### Modification 3

In the embodiment, the power supply device 1 transmits the request signal of the measurement to the power reception device 2, and the power reception device 2 receives the request signal of the measurement and measures the received electric energy from the wireless signal. In this modification, the power supply device 1 transmits a signal indicating a time length for transmitting the wireless power supply signal to the power reception device 2, and the power reception device 2 receives the signal, compares the time length with a time length determined to include the wireless power supply signal, and may determine whether the transmission of the signal indicating the electric energy is necessary or not.

An operation of the power supply device 1 in this modification is different in step S11. The controller 101 generates a signal (also referred to as a third signal) indicating the time length for transmitting the wireless power supply signal instead of generating the request signal of the measurement of electric energy to be received of the power reception device 2. The communication circuit 13 transmits the signal to the power reception device 2 through the antenna 14 (step S11′). After the step S12, it is the same as the explanation in the first embodiment.

The step S21 and the step S25 are different in an operation of the power reception device 2 in this modification. Except for these steps, it is the same as the description in the first embodiment. A step S21′ as a substitute for the step S21 is explained. The communication circuit 24 receives the signal indicating the time length for the power supply device 1 to transmit the wireless power supply signal instead of receiving the request signal of the measurement of the electric energy to be received by the power reception device 2 through the antenna 25. The controller 201 sets the time-out timer (time Tr) (step S21′).

A step S25′ as a substitute for the step S25 is explained. The controller 201 determines whether the wireless signal determined to include the wireless power supply signal is received during a first time to a second time length based on the measurement result sent from the measurement circuit 23 or not (step S25′). The first time and the second time length are based on the time length when the power supply device 1 transmits the wireless power supply signal (hereinafter referred to as a power supply time length). When it is determined that the wireless power supply signal is not included in the received wireless signal, or when the time for receiving the wireless signal including the wireless power supply signal does not satisfy a condition even if the wireless power supply signal is included in the received wireless signal (step S25′: No), the process returns to the step S22. The process may return to the step S21′. When the wireless power supply signal is included in the received wireless signal and the time for receiving the wireless signal including the wireless power supply signal satisfies the condition (step S25′: Yes), the process proceeds to the step S26.

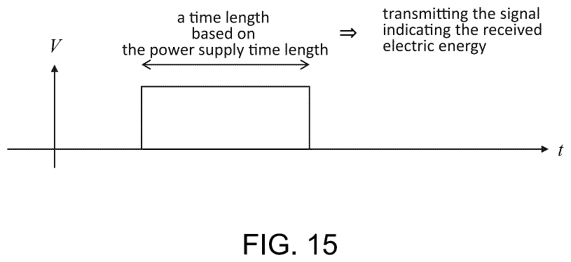

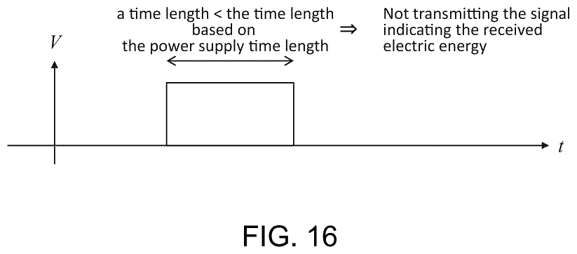

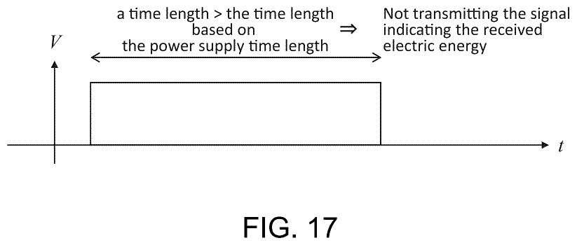

FIG. 15-FIG. 17 are diagrams illustrating three examples of the necessity of transmission of the signal indicating the received electric energy of the power reception device 2 in this modification. A first example in FIG. 15 represents a case where the time for receiving the wireless signal including the wireless power supply signal is within a time length based on the power supply time length. In this case, the controller 201 determines to generate and transmit the signal indicating the received electric energy. A second example in FIG. 16 represents a case where the time for receiving the wireless signal including the wireless power supply signal is shorter than the time length based on the power supply time length. In this case, the controller 201 determines not to generate the signal indicating the electric energy and not to transmit it. A third example in FIG. 17 represents a case where the time for receiving the wireless signal including the wireless power supply signal is longer than the time length based on the power supply time length. In this case, the controller 201 determines not to generate the signal indicating the electric energy and not to transmit it.

As shown in this modification, the power supply device 1 notifies the power reception device 2 of the power supply time length, so that the power reception device 2 can determine whether the wireless power supply signal transmitted by the power supply device 1 is received corresponding to the time when the power reception device 2 receives the wireless signal determined to include the wireless power supply signal. Even when a wireless communication terminal 3′ for transmitting and receiving a signal not including communication data exists in the vicinity of the power supply system 100, the power reception device 2 can determine whether the wireless power supply signal from the power supply device 1 is included or not.

Also, the following means can be used to share the time length for transmitting the wireless power supply signal between the power supply device 1 and the power reception device 2. As the means 1, the time length for transmitting the wireless power supply signal may be predetermined as a specification or a standard of the wireless power supply between the power supply device 1 and the power reception device 2. As the means 2, the time length for transmitting the wireless power supply signal from the power supply device 1 to the power reception device 2 may be set by input via a user interface or the like.

### Modification 4

In the embodiment, the power reception device 2 determines whether the wireless power supply signal transmitted by the power supply device 1 is included in the wireless signal based on the feature value of the wireless signal. In this modification, the power supply device 1 also determines whether the power reception device 2 receives the wireless power supply signal based on a transmission time of the wireless power supply signal by the power supply device 1 or a reception time of the wireless signal determined to include the wireless power supply signal by the power reception device 2 or not.

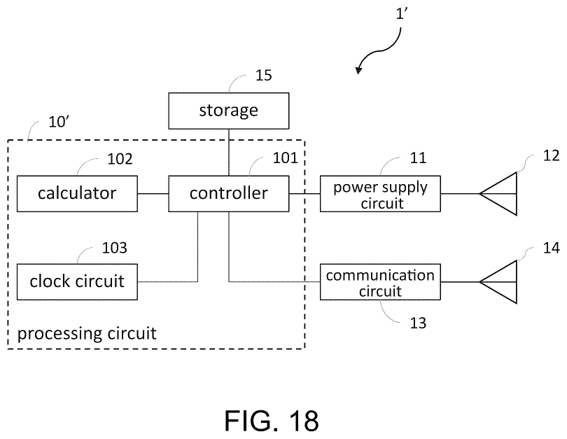

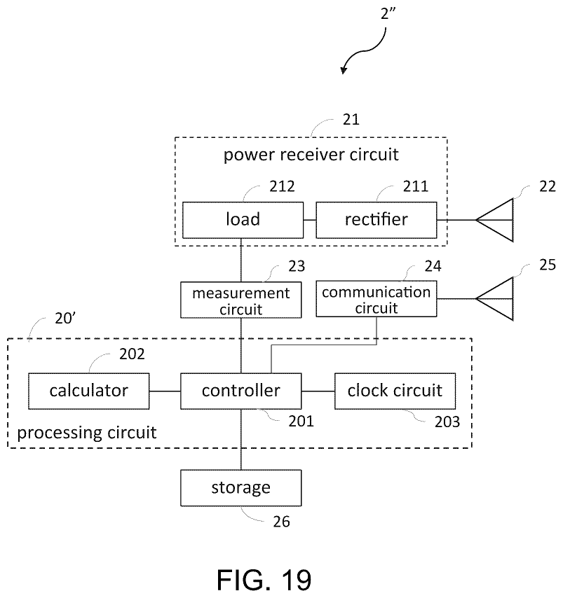

FIG. 18 is a diagram illustrating a configuration example of a power supply device 1′ applicable to the first embodiment, and FIG. 19 is a diagram illustrating a configuration example of a power reception device 2″ applicable to the first embodiment. In the power supply device 1′, the processing circuit 10 of the power supply device 1 is changed to a processing circuit 10′. In the power reception device 1″, the processing circuit 20 of the power reception device 2 is changed to a processing circuit 20′. The processing circuit 10′ further includes a clock circuit 103 in the processing circuit 10. The processing circuit 20′ further includes a clock circuit 203 in the processing circuit 20.

The clock circuit 103 records the transmission time (may be called a first time) of the wireless power supply signal by the power supply circuit 11. As the transmission time of the wireless power supply signal, the clock circuit 103 may record the time simultaneously with or immediately after the transmission of the wireless power supply signal from the power supply circuit 11, or the clock circuit 103 may record the transmission time of the wireless power supply signal instructed to the power supply circuit 11 by the controller 101.

The clock circuit 203 records the reception time (second time) of the wireless signal determined to include the wireless power supply signal. As the reception time of the wireless signal determined to include the wireless power supply signal, the time simultaneous with or immediately after the determination that the wireless power supply signal is included may be recorded, or an end time of a time slot determined to include the wireless power supply signal may be recorded, or any time during the time slot may be recorded.

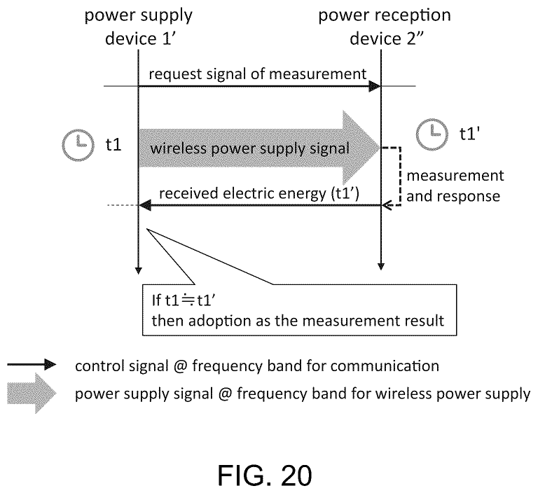

FIG. 20 is a sequence diagram illustrating operation examples of the power supply device 1′ and the power reception device 2″ in the modification. FIG. 20 represents processes from the transmission of the request signal of the measurement of the electric energy to be received to the reception of the signal indicating the received electric energy. The transmission is performed from the power supply device 1′ to the power reception device 2″, and the reception is performed from the power reception device 2″ by the power supply device 1′.

First, the power supply device 1′ transmits the request signal of the measurement of the electric energy to be received to the power reception device 2″, and the power reception device 2″ receives it. Next, the power supply device 1′ transmits the wireless power supply signal to the power reception device 2″. Here, the power supply device 1′ records the transmission time t1 of the wireless power supply signal. The power reception device 2″ receives the wireless power supply signal. Here, the power reception device 2″ records a reception time t1′ of the wireless signal determined to include the wireless power supply signal. The power reception device 2″ transmits the signal indicating the received electric energy to the power supply device 1′ in association with the reception time t1′, and the power supply device 1′ receives it.

Hereinafter, the power supply device 1′ compares the transmission time t1 with the reception time t1′, and since the reception time t1′ is within a predetermined time slot which is based on the transmission time t1, the power supply device 1′ determines the item related to the transmission of the wireless power supply signal from the received electric energy.

Different points of steps of the power supply device 1′ and the power supply device 1 are explained, and different points of steps of the power reception device 2″ and the power reception device 2 are explained. Steps other than steps including the different points are the same as the steps described in the embodiment. In the power supply device 1′, the clock circuit 103 records the transmission time of the wireless power supply signal in addition to the transmission of the wireless power supply signal in the step S12 (step S12′). The transmission time is sent to the controller 101 and may be held in the storage 15 until it is used.

The controller 101 determines whether the power reception device 2 receives the wireless power supply signal transmitted by the power supply circuit 11 based on the transmission time t1 of the wireless power supply signal and the reception time t1′ of the wireless signal determined to include the wireless power supply signal by the power supply circuit 11 (step S18). In more detail, the controller 101 sets the predetermined time slot based on the transmission time t1 of the wireless power supply signal by the power supply circuit 11 and determines whether the power reception device 2 receives the wireless power supply signal transmitted by the power supply circuit 11 according to whether the reception time t1′ is included in the time slot or not. The step S18 is preferably set between the step S13 and the step S15 of the power supply device 1. When the controller 101 determines that the power reception device 2 receives the wireless power supply signal transmitted by the power supply circuit 11 (step S18: Yes), the process is shifted to a step S14 (when the step S18 is between steps S13 and s14) or a step S15 (when the step S18 is between the steps s14 and s15). When the controller 101 determines that the power reception device 2 does not receive the wireless power supply signal transmitted by the power supply circuit 11 (step S18: No), the process returns to the step S11.

In the power reception device 2″, the controller 201 generates and transmits information indicating the reception time t1′ of the wireless signal determined to include the wireless power supply signal in addition to the signal indicating the received electric energy in the step S26 (step S26′).

Thus, the power supply device 1 can also determine whether the power reception device 2 has received the wireless power supply signal or not and transmit the request signal of the measurement of the electric energy to be received by the power reception device 2 again.

### Modification 5

In the embodiment, the power reception device 2 determines whether the wireless power supply signal from the power supply device 1 is included in the received wireless signal. In this modification, the power reception device 2 may not determine whether the wireless power supply signal is included in the received wireless signal, and instead may measure the DC power of the received wireless signal, and may generate and transmit the signal indicating the electric energy with a statistic of the DC power as the electric energy.

In this case, the power reception device 2 does not confirm the condition of the feature value in the step S25, receives the wireless signal and measures the feature value (DC power) in the step S24, and generates and transmits the signal indicating the received electric energy with the statistic of the measured DC power as the received power value in the step S26. At least one of the statistics of the DC power is, for example, a minimum value, a maximum value, an average value, a median value, or a variance or the like of the DC power. The statistic may be time series data. The other steps are the same as the steps of the power reception device 2.

The power supply device 1 confirms whether the electric energy received by the power reception device 2 satisfies a predetermined condition by using the feature value of the DC power transmitted from the power reception device 2 in the step S14. The other steps are the same as the steps of the power supply device 1.

Thus, the power supply device 1 can determine whether the power reception device 2 has received the wireless power supply signal, not the power reception device 2.

### Modification 6

In the embodiment, the frequency band (5.7 GHZ band) of the wireless power supply signal transmitted by the power supply device 1 and received by the power reception device 2 is different from the frequency band (2.4 GHz band) of the wireless communication signal transmitted and received by the power supply device 1 and the power reception device 2. In this modification, these frequency bands may be the same frequency bands. For example, the frequency band of the wireless communication signal transmitted and received by the power supply device 1 and the power reception device 2 may be the frequency band (5 GHz band) in the vicinity of the frequency of the wireless power supply signal or may be a closer (similar) frequency band.

Even if the frequency band of the wireless power supply signal and the frequency band of the wireless communication signal are the same frequency band, the wireless power supply signal and the wireless communication signal have different the feature value as explained in the embodiment. The power reception device 2 can determine whether the wireless power supply signal is included by measuring the feature value of the received wireless signal or not.

### Modification 7

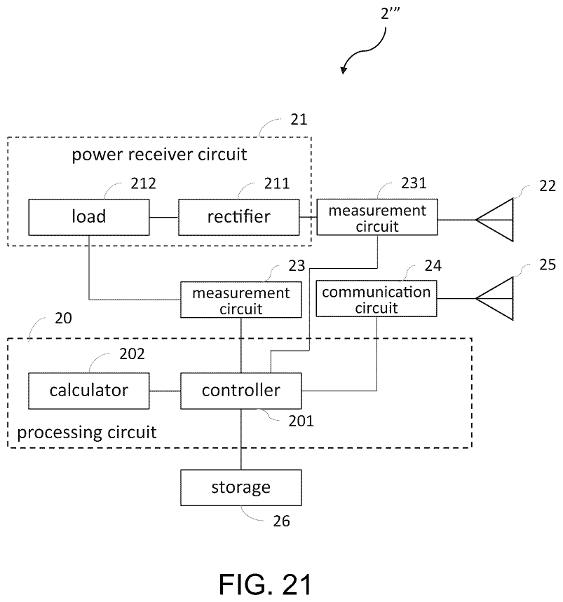

In the embodiment, at least one of the amplitude or the time change of the amplitude is used as the feature value of the wireless power supply signal. In this modification, the time change of the frequency is used as the feature value of the wireless power supply signal. FIG. 21 is a diagram illustrating a configuration example of a power reception device 2″ applicable to the first embodiment. The power reception device 2″″ further includes a measurement circuit 231 in addition to the power reception device 2.

In this modification, at least one of the feature values of the wireless power supply signal transmitted by the power supply device 1 may defined as:
the time change of the frequency is within a positive predetermined range (may be called a fourth range),
the time change of the frequency is within a negative predetermined range (may be called a fifth range),
the time change of the frequency is within a positive predetermined range (may be called a sixth range) in the first time slot and a negative predetermined range (may be called a seventh range) in the second time slot (the first time slot and the second time slot are included in a predetermined time slot), or
the time change of the frequency is within a negative predetermined range (may be called an eighth range) in a third time slot and a positive predetermined range (in a ninth range) in a fourth time slot (the third time slot and the fourth time slot are included in the predetermined time slot). When the time change of the frequency is positive, it is called an up chirp, and when the time change of the frequency is negative, it is called a down chirp. In addition, the fourth range to the ninth range may be set in consideration of the fluctuation of amplitude or phase called fading, the noise, the reflection, or the diffraction in the actual environment.

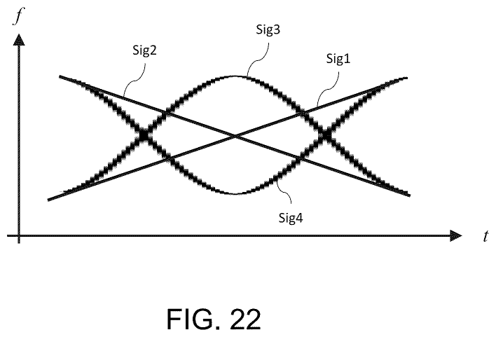

FIG. 22 is a diagram illustrating an example of the frequency of the wireless power supply signal of the power supply device 1 in the modification. Sig1 represents an example of the wireless power supply signal in which the time change of the frequency is within the positive fourth range, Sig2 represents an example of the wireless power supply signal in which the time change of the frequency is within the negative fifth range. Sig3 represents an example of the wireless power supply signal in which the time change of the frequency within the positive sixth range in the first time slot and within the negative seventh range in the second time slot. Sig 4 represents an example of the wireless power supply signal in which the time change of the frequency is within the positive eighth range in the third time slot and within the negative ninth range in the fourth time slot.

The measurement circuit 231 (which may be called a second measurement circuit) measures the time change of the frequency of the wireless signal received through the antenna 22. The measurement circuit 231 sends the wireless signal to the rectifier 211 and sends information indicating the time change of the measured frequency to the controller 201. The controller 201 may determine whether the received wireless signal includes the wireless power supply signal based on the time change of the frequency of the wireless signal or not.

Differences between steps of an operation of the power reception device 2′″ and the steps of the operation of the power reception device 2 is explained. The measurement circuit 231 measures the time change of the frequency of the received wireless signal (step S24′) instead of the measurement of the feature value in the step S24. The controller 201 confirms whether a condition of the feature value is satisfied or not based on the time change of the frequency of the wireless signal received by the controller 201 (step S25″). More specifically, when the time change of the frequency of the received wireless signal corresponds to any of the fourth range to the ninth range, the controller 201 determines that the wireless power supply signal transmitted by the power supply device 1 is included in the received wireless signal.

As in this modification, the power reception device 2 can determine whether the received wireless signal includes the wireless power supply signal or not by measuring the time change of the frequency of the received wireless signal as the feature value.

### Modification 8

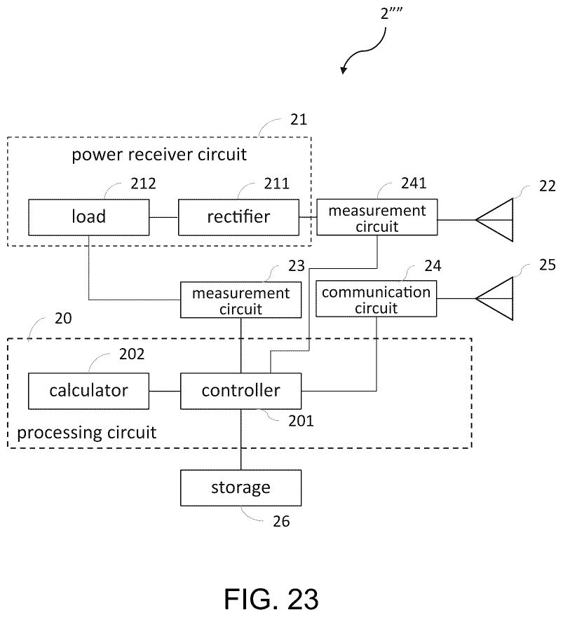

In the embodiment, the amplitude and the time change of the amplitude are used as the feature value of the wireless power supply signal. In this modification, a frequency spectrum is used as the feature value of the wireless power supply signal. FIG. 23 is a diagram illustrating a configuration example of the power reception device 2″″ applicable to the first embodiment. The power reception device 2″″ further includes a measurement circuit 241 in addition to the power reception device 2.

The measurement circuit 241 (which may be called a third measurement circuit) measures a frequency spectrum of the wireless signal received through the antenna 22. The measurement circuit 241 sends the wireless signal to the rectifier 211 and sends information indicating the measured frequency spectrum to the controller 201. The controller 201 may determine whether the received wireless signal includes the wireless power supply signal based on the frequency spectrum of the wireless signal or not. More specifically, the controller 201 may determine whether the received wireless signal includes the wireless power supply signal based on at least one of a width or the time change of the frequency spectrum of the wireless signal or not.

In this modification, the power supply device 1 transmits the wireless power supply signal as a non-modulated sine wave. In the wireless power supply signal, the frequency spectrum in a predetermined frequency band (which may be called a first frequency band) is settled within a predetermined width. Also, in the wireless power supply signal, the time change of the frequency spectrum is settled within a predetermined range. The range of the predetermined width or the predetermined time change of the frequency spectrum may be set in consideration of noise, reflection, diffraction, or fluctuation of amplitude and phase called fading in the real environment. The frequency spectrum of the wireless communication signal is different from the wireless power supply signal of this modification, having a width exceeding the predetermined width and a time change exceeding the range of the predetermined time change.

Differences between steps of an operation of the power reception device 2″″ and the steps of the operation of the power reception device 2 is explained. The measurement circuit 241 measures the frequency spectrum of the received wireless signal (step S24″) instead of the measurement of the feature value in the step S24. The controller 201 confirms whether a condition of the feature value is satisfied or not based on at least one of the width or the time change of the frequency spectrum of the wireless signal received by the controller 201 (step S25′″). More specifically, when the width of the frequency spectrum of the received wireless signal is within a predetermined range in a predetermined frequency band or the time change of the frequency spectrum of the received wireless signal is within the predetermined range, the controller 201 determines that the wireless power supply signal transmitted by the power supply device 1 is included in the received wireless signal.

As in this modification, the power reception device 2 measures the frequency spectrum of the received wireless signal as the feature value, thereby the power reception device 2 can determine whether the wireless signal to be received includes the wireless power supply signal or not.

The modifications of the power supply device 1 and the power reception device 2 are explained above. The power supply device 1 according to the embodiment and the modifications transmits the wireless power supply signal including the feature value different from the wireless communication signal. The power reception device of the embodiment and the modifications determine whether the wireless power supply signal is included in the wireless signal based on the feature value of the received wireless signal. Thus, the power reception device 2 can discriminate whether the received wireless signal is the wireless power supply signal or the other wireless communication signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments and modifications as described before may be configured as below.

### Clauses

Clause 1. A power reception device, comprising:
a power receiver circuit configured to receive a wireless signal including at least one of a wireless power supply signal or a wireless communication signal; and
a processing circuit configured to determine whether the wireless signal includes the wireless power supply signal or not from a feature value of the wireless signal.

Clause 2. The power reception device according to clause 1, further comprising:
a communication circuit configured to receive a first signal from a power supply device which is a transmission source hereafter of the wireless power supply signal, the first signal indicating a request to measure electric energy received by the power reception device; and
a first measurement circuit configured to measure the electric energy received from the wireless signal, wherein,
the processing circuit generates a second signal based on the first signal, the second signal indicates electric energy received by a wireless signal determined to include the wireless power supply signal within a predetermined time, and
a communication circuit transmits the second signal to the power supply device.

Clause 3. The power reception device according to clause 1, further comprising a first measurement circuit configured to measure electric energy received from the wireless signal, wherein
the processing circuit generates a second signal indicating electric energy received by the wireless signal when the power receiver circuit receives a wireless signal determined to include the wireless power supply signal during a period from a first time length to a second time length based on a time length when the power supply device transmits the radio power supply signal, and
the power reception device further comprises a communication circuit transmitting the second signal to the power supply device.

Clause 4. The power reception device according to clause 1, further comprising a first measurement circuit configured to measure electric energy received from the wireless signal, wherein,
the processing circuit includes a clock circuit configured to record a first time when the wireless signal determined to include the wireless power supply signal is received,
the processing circuit generates a second signal indicating electric energy and the first time, wherein the electric energy is received by a wireless signal determined to include the wireless power supply signal within a predetermined time, and
the power reception device further comprises a communication circuit transmitting the second signal to the power supply device which is a transmission source of the wireless power supply signal.

Clause 5. The power reception device according to any one of clause 1 to 4, wherein,
the power receiver circuit receives power by converting the wireless signal into DC power, and
the processing circuit determines whether or not the wireless signal includes the wireless power supply signal based on at least one of a value of the DC power or a time change of the DC power as the feature value of the wireless signal.

Clause 6. The power reception device according to clause 5, wherein the processing circuit determines that the wireless signal includes the wireless power supply signal in at least one of cases:
when the value of the DC power is within a first range within a predetermined time;
when the time change of the DC power is within a positive second range within a predetermined time; or
when the time change of the DC power is within a negative third range within a predetermined time.

Clause 7. The power reception device according to any one of clause 1 to 6, further comprising a second measurement circuit configured to measure at least one of a frequency of the wireless signal or a time change of the frequency, wherein,
the processing circuit determines whether or not the wireless signal includes the wireless power supply signal based on the time change of the frequency as the feature value of the wireless signal.

Clause 8. The power reception device according to clause 7, wherein the processing circuit determines that the wireless signal includes the wireless power supply signal in at least one of cases:
when the time change of the frequency is within a positive fourth range within a predetermined time;
when the time change of the frequency is within a negative fifth range within a predetermined time;
when the time change of the frequency is within a positive sixth range in a first time slot and within a negative seventh range in a second time slot, the first time slot and the second time slot within a predetermined time; or
when the time change of the frequency is within a negative eighth range in a third time slot and within a positive ninth range in a fourth time slot, the third time slot and the fourth time slot within a predetermined time.

Clause 9. The power reception device according to any one of clause 1 to 8, further comprising a third measurement circuit configured to measure a frequency spectrum of the wireless signal, wherein,
the processing circuit determines whether or not the wireless signal includes the wireless power supply signal based on at least one of a width of the frequency spectrum or a time change of the frequency spectrum as the feature value of the wireless signal.

Clause 10. A power supply device, comprising:
a processing circuit configured to generate a wireless power supply signal including a different feature value from a wireless communication signal; and
a power supply circuit configured to transmit the wireless power supply signal.

Clause 11. The power supply device according to clause 10, wherein the processing circuit generates a first signal indicating a request to measure electric energy received by a power reception device which is a transmission destination of the wireless power supply signal, and
the power supply device further comprises a communication circuit configured to:
   transmit the first signal to the power reception device; and
   receive a second signal from the power reception device after the communication circuit transmits the wireless power supply signal, the second signal indicating electric energy received by the power reception device, and wherein
the processing circuit determines at least one of a time slot, a time length, an amplitude, a phase, a frequency band or a direction for transmitting the wireless power supply signal based on the second signal.

Clause 12. The power supply device according to clause 10, wherein the processing circuit generates a first signal indicating a request to measure electric energy received by a power reception device which is a transmission destination of the wireless power supply signal, and
the power supply device further comprises a communication circuit configured to:
   transmit the first signal to the power reception device; and
   receive a second signal from the power reception device after the communication circuit transmits the wireless power supply signal, the second signal indicating electric energy received by the power reception device, and wherein
the processing circuit generates the first signal when the communication circuit does not receive the second signal within a predetermined time, when the electric energy included in the second signal received by the power reception device is a predetermined value or less, or when the communication circuit receives a signal requesting retransmission of the first signal from the power reception device, and
the communication circuit transmits the first signal.

Clause 13. The power supply device according to clause 10, wherein the processing circuit generates a first signal indicating a time length for transmitting the wireless power supply signal to a power reception device which is a transmission destination of the wireless power supply signal, and
the power supply device further comprises a communication circuit configured to:
   transmit the first signal to the power reception device; and
   receive a second signal from the power reception device after the communication circuit transmits the wireless power supply signal, the second signal indicating electric energy received by the power reception device, and wherein
the processing circuit determines at least one of a time slot, a time length, an amplitude, a phase, a frequency band or a direction for transmitting the wireless power supply signal based on the second signal.

Clause 14. The power supply device according to clause 10, wherein the processing circuit includes a clock circuit configured to record a first time for transmitting the wireless power supply signal, and
the power supply device further comprises a communication circuit configured to receive a second signal from the power reception device after the communication circuit transmits the wireless power supply signal, the second signal indicating electric energy received by the power reception device and including second time when the power reception device receives a wireless signal to be determined to include the wireless power supply signal, and wherein
the processing circuit determines whether or not the power reception device received the wireless supply signal based on the first time and the second time.

Clause 15. The power supply device according to clause 10, further comprising a communication circuit configured to receive a second signal from the power reception device after the communication circuit transmits the wireless power supply signal, the second signal indicating electric energy received by the power reception device, and wherein,

The second signal includes information indicating a statistic of the received electric energy, and
the processing circuit determines at least one of a time slot, a time length, an amplitude, a phase, a frequency band or a direction for transmitting the wireless power supply signal based on the second signal.

Clause 16. The power supply device according to any one of clause 10 to 15, wherein the processing circuit generates the wireless power supply signal in which an amplitude is within a first range, a time change of the amplitude is within a positive second range, or a time change of the amplitude is within a negative third range, as the different feature value.

Clause 17. The power supply device according to any one of clause 10 to 16, wherein the processing circuit generates the wireless power supply signal in which at least one of:
a time change of a frequency is within a positive fourth range;
the time change of the frequency is within a negative fifth range;
the time change of the frequency is within a positive sixth range in a first time slot and within a negative seventh range in a second time slot; or
the time change of the frequency is within a negative eighth range in a third time slot and within a positive ninth range in a fourth time slot, as the different feature value.

Clause 18. A power supply system, comprising: the power reception device according to any one of clause 1 to 9; and
the power supply device according to any one of clause 10 to 17.

Clause 19. A method, comprising:
receiving a wireless signal including at least one of a wireless power supply signal or a wireless communication signal; and
determining whether the wireless signal includes the wireless power supply signal or not from a feature value of the wireless signal.

Clause 20. A method, comprising:
generating a wireless power supply signal including a different feature value from a wireless communication signal; and
transmitting the wireless power supply signal.

1. A power reception device, comprising:
a power receiver circuit configured to receive a wireless signal including at least one of a wireless power supply signal or a wireless communication signal; and
a processing circuit configured to determine whether the wireless signal includes the wireless power supply signal or not from a feature value of the wireless signal.

2. The power reception device according to claim 1, further comprising:
a communication circuit configured to receive a first signal from a power supply device which is a transmission source hereafter of the wireless power supply signal, the first signal indicating a request to measure electric energy received by the power reception device; and
a first measurement circuit configured to measure the electric energy received from the wireless signal, wherein,
the processing circuit generates a second signal based on the first signal, the second signal indicates electric energy received by a wireless signal determined to include the wireless power supply signal within a predetermined time, and
a communication circuit transmits the second signal to the power supply device.

3. The power reception device according to claim 1, further comprising a first measurement circuit configured to measure electric energy received from the wireless signal, wherein
the processing circuit generates a second signal indicating electric energy received by the wireless signal when the power receiver circuit receives a wireless signal determined to include the wireless power supply signal during a period from a first time length to a second time length based on a time length when the power supply device transmits the radio power supply signal, and
the power reception device further comprises a communication circuit transmitting the second signal to the power supply device.

4. The power reception device according to claim 1, further comprising a first measurement circuit configured to measure electric energy received from the wireless signal, wherein,
the processing circuit includes a clock circuit configured to record a first time when the wireless signal determined to include the wireless power supply signal is received,
the processing circuit generates a second signal indicating electric energy and the first time, wherein the electric energy is received by a wireless signal determined to include the wireless power supply signal within a predetermined time, and
the power reception device further comprises a communication circuit transmitting the second signal to the power supply device which is a transmission source of the wireless power supply signal.

5. The power reception device according to claim 1, wherein,
the power receiver circuit receives power by converting the wireless signal into DC power, and
the processing circuit determines whether or not the wireless signal includes the wireless power supply signal based on at least one of a value of the DC power or a time change of the DC power as the feature value of the wireless signal.

6. The power reception device according to claim 5, wherein the processing circuit determines that the wireless signal includes the wireless power supply signal in at least one of cases:
when the value of the DC power is within a first range within a predetermined time;
when the time change of the DC power is within a positive second range within a predetermined time; or
when the time change of the DC power is within a negative third range within a predetermined time.

7. The power reception device according to claim 1, further comprising a second measurement circuit configured to measure at least one of a frequency of the wireless signal or a time change of the frequency, wherein,
the processing circuit determines whether or not the wireless signal includes the wireless power supply signal based on the time change of the frequency as the feature value of the wireless signal.

8. The power reception device according to claim 7, wherein the processing circuit determines that the wireless signal includes the wireless power supply signal in at least one of cases:
when the time change of the frequency is within a positive fourth range within a predetermined time;
when the time change of the frequency is within a negative fifth range within a predetermined time;
when the time change of the frequency is within a positive sixth range in a first time slot and within a negative seventh range in a second time slot, the first time slot and the second time slot within a predetermined time; or
when the time change of the frequency is within a negative eighth range in a third time slot and within a positive ninth range in a fourth time slot, the third time slot and the fourth time slot within a predetermined time.

9. The power reception device according to claim 1, further comprising a third measurement circuit configured to measure a frequency spectrum of the wireless signal, wherein,
the processing circuit determines whether or not the wireless signal includes the wireless power supply signal based on at least one of a width of the frequency spectrum or a time change of the frequency spectrum as the feature value of the wireless signal.

10. A power supply device, comprising:
a processing circuit configured to generate a wireless power supply signal including a different feature value from a wireless communication signal; and
a power supply circuit configured to transmit the wireless power supply signal.

11. The power supply device according to claim 10, wherein the processing circuit generates a first signal indicating a request to measure electric energy received by a power reception device which is a transmission destination of the wireless power supply signal, and
the power supply device further comprises a communication circuit configured to:
transmit the first signal to the power reception device; and
receive a second signal from the power reception device after the communication circuit transmits the wireless power supply signal, the second signal indicating electric energy received by the power reception device, and wherein
the processing circuit determines at least one of a time slot, a time length, an amplitude, a phase, a frequency band or a direction for transmitting the wireless power supply signal based on the second signal.

12. The power supply device according to claim 10, wherein the processing circuit generates a first signal indicating a request to measure electric energy received by a power reception device which is a transmission destination of the wireless power supply signal, and
the power supply device further comprises a communication circuit configured to:
transmit the first signal to the power reception device; and
receive a second signal from the power reception device after the communication circuit transmits the wireless power supply signal, the second signal indicating electric energy received by the power reception device, and wherein
the processing circuit generates the first signal when the communication circuit does not receive the second signal within a predetermined time, when the electric energy included in the second signal received by the power reception device is a predetermined value or less, or when the communication circuit receives a signal requesting retransmission of the first signal from the power reception device, and
the communication circuit transmits the first signal.

13. The power supply device according to claim 10, wherein the processing circuit generates a first signal indicating a time length for transmitting the wireless power supply signal to a power reception device which is a transmission destination of the wireless power supply signal, and
the power supply device further comprises a communication circuit configured to:
transmit the first signal to the power reception device; and
receive a second signal from the power reception device after the communication circuit transmits the wireless power supply signal, the second signal indicating electric energy received by the power reception device, and wherein
the processing circuit determines at least one of a time slot, a time length, an amplitude, a phase, a frequency band or a direction for transmitting the wireless power supply signal based on the second signal.

14. The power supply device according to claim 10, wherein the processing circuit includes a clock circuit configured to record a first time for transmitting the wireless power supply signal, and
the power supply device further comprises a communication circuit configured to receive a second signal from the power reception device after the communication circuit transmits the wireless power supply signal, the second signal indicating electric energy received by the power reception device and including second time when the power reception device receives a wireless signal to be determined to include the wireless power supply signal, and wherein
the processing circuit determines whether or not the power reception device received the wireless supply signal based on the first time and the second time.

15. The power supply device according to claim 10, further comprising a communication circuit configured to receive a second signal from the power reception device after the communication circuit transmits the wireless power supply signal, the second signal indicating electric energy received by the power reception device, and wherein,
The second signal includes information indicating a statistic of the received electric energy, and
the processing circuit determines at least one of a time slot, a time length, an amplitude, a phase, a frequency band or a direction for transmitting the wireless power supply signal based on the second signal.

16. The power supply device according to claim 10, wherein the processing circuit generates the wireless power supply signal in which an amplitude is within a first range, a time change of the amplitude is within a positive second range, or a time change of the amplitude is within a negative third range, as the different feature value.

17. The power supply device according to claim 10, wherein the processing circuit generates the wireless power supply signal in which at least one of:
a time change of a frequency is within a positive fourth range;
the time change of the frequency is within a negative fifth range;
the time change of the frequency is within a positive sixth range in a first time slot and within a negative seventh range in a second time slot; or
the time change of the frequency is within a negative eighth range in a third time slot and within a positive ninth range in a fourth time slot, as the different feature value.

18. A power supply system, comprising:
the power reception device according to claim 1; and
a power supply device being a transmission source of the wireless power supply signal.

19. A method, comprising:
receiving a wireless signal including at least one of a wireless power supply signal or a wireless communication signal; and
determining whether the wireless signal includes the wireless power supply signal or not from a feature value of the wireless signal.

20. A method, comprising:
generating a wireless power supply signal including a different feature value from a wireless communication signal; and
transmitting the wireless power supply signal.
